(19) United States
(12) Patent Application Publication
(10) Pub. No.: US 2010/0034609 A1
(43) Pub. Date: Feb. 11, 2010

(54) Method and system for reducing milling failure

(75) Inventor: Edward Jacobus Johannes Doppenberg, Delft (NL)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Nederlandse Organisatie voor toegepast- natuurwetenschappelijk Onderzoek TNO, Delft (NL)

(21) Appl. No.: 12/530,116

(22) PCT Filed: Mar. 10, 2008
(86) PCT No.: PCT/NL08/50139

§ 371 Date: Oct. 1, 2009

(30) Foreign Application Priority Data
Mar. 8, 2007 (EP) 07103787.3

(51) Int. Cl. B23Q 11/00

(52) U.S. Cl. 409/131; 409/134

(57) ABSTRACT

Method for reducing milling failure in a machining tool due to coincidence between first vibrations v1 substantially caused by mutually exerted forces between the machining tool and an object being machined, and second vibrations v2 substantially caused by mechanical resonance by or in the machining tool itself and/or one or more subsystems of the machining tool. The method comprising the steps of detecting frequencies of v1 and the frequencies of v2; determining the extent of the coincidence between the frequencies of v1 and the frequencies of v2. If the extent of coincidence between the frequencies of v1 and at least one of any of the frequencies of v2 is within a certain range, the vibration causing said coincidence between the frequencies of v1 and at least one of any of the frequencies of v2 is counteracted. To counteract said coincidence the respective frequencies of v1 and v2 one or more machining parameters may changed or relevant vibrational characteristics of the machining tool itself are changed by means of passive or active components, e.g. actuators.

### FIELD OF THE INVENTION

The invention concerns a method and a system for reducing milling failure in a machining tool.

### BACKGROUND

Milling failure in a machining tool may be due to coincidence between vibrations (v1) substantially caused by mutually exerted forces between the machining tool and an object being machined, and vibrations (v2) which are substantially caused by mechanical resonance by or in the machining tool itself and/or subsystems of the machining tool.

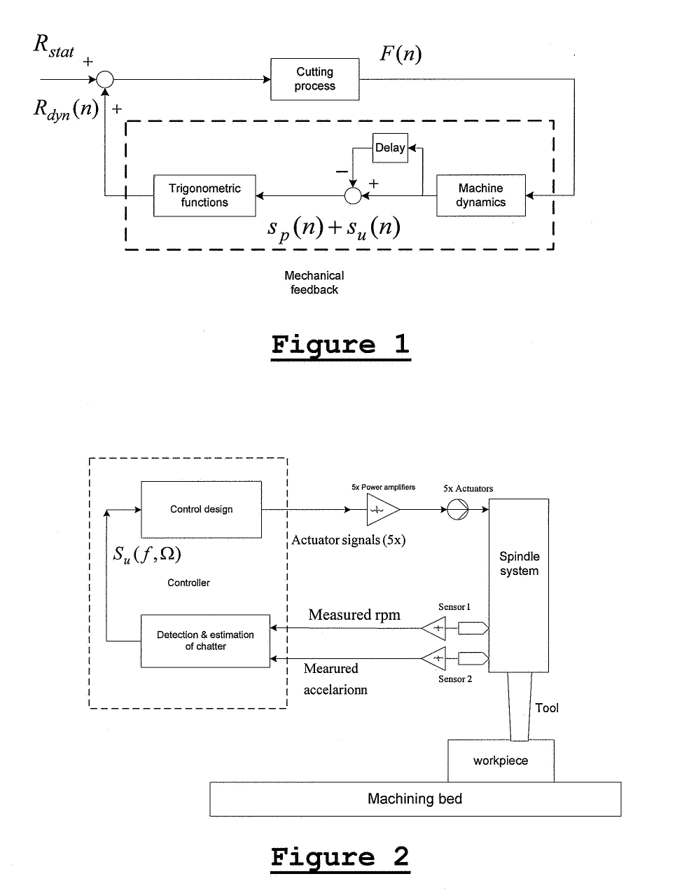

In FIG. 1, a block diagram of the milling process is shown. The static thickness hₛₜₐₜ is a result of the pre-defined motion (cutting) of the tool with respect to the work piece. The chip thickness results in the force F(t) that acts on the tool via the cutting process (block Cutting process). Interaction of this force with the spindle and tool dynamics (block Machine dynamics), results in a dynamic displacement of the tool sₚ(t), which is superimposed on the pre-defined tool motion. Via mechanical feedback (block Mechanical feedback), a dynamic chip thickness R_{dyn}(t) is added to the static chip thickness.

In the milling process, the static chip thickness is periodic, with a period time

$$T = τ = \frac{1}{{f}_{t}} = \frac{60}{{N}_{z} Ω} .$$

Here, τ is the delay as mentioned in the block Delay (due to the regenerative effect), N_{z} is the number of teeth on the cutter, and Ω the spindle speed in rpm. The block Delay is a perturbation on that periodic movement is denoted by sᵤ(t). If no chatter occurs, the periodic movement sₚ(t) is stable, and the perturbation motion sᵤ(t) tends to zero asymptotically. When the periodic movement sₚ(t) becomes unstable (i.e. with an increasing axial depth-of-cut), the perturbation sᵤ(t) with a different frequency f_{c} is superimposed on the original movement sₚ(t). This perturbation motion sᵤ(t) is strongly correlated with the dynamic chip thickness R_{dyn}(t) and can be used as a measure for R_{dyn}(t). Here f_{c} is referred to as the basic chatter frequency.

The unstable perturbation movement is referred to as ‘chatter’. The change from stable to unstable movement is general referred to as the onset to ‘chatter’.

From U.S. Pat. No. 5,170,358 a method to control reduction of chatter is known. Chatter is detected by calculating the frequency spectrum of relative vibrations between the tool and the workpiece and the identification of peaks in the spectrum that represent chatter. Information from the peaks is then used to change the rotation speed of the tool. In order to do this, the feed of the cutting tool relative to the workpiece is interrupted and during the interruption the speed of rotation is changed. The interruption makes it possible to open up the servo control loops that control the tool, to avoid damage due to the change of rotation speed.

Various measures have been proposed earlier to reduce chatter. U.S. Pat. No. 4,047,469 discloses that chatter can be reduced by using an auxiliary tool holder to change the natural frequency of the tool. U.S. Pat. No. 6,189,426 discloses control of tool stiffness for this purpose. U.S. Pat. No. 3,967,515 discloses use of a compensatory force actuator to offset measured vibrational chatter. EP 1288745 discloses the adjustment of speed loop gain to mitigate the effect of chatter on the speed control loop.

### SUMMARY

It is an object to reduce milling failure in a machining tool due to chatter.

Effectively milling failure may be due to coincidence between the fundamental frequency and/or at least one harmonic frequency of first vibrations v1 substantially caused by mutually exerted forces between the machining tool and an object being machined, and the fundamental frequency and/or at least one harmonic frequency of second vibrations v2 substantially caused by mechanical resonance by or in the machining tool itself and/or one or more subsystems of the machining tool.

Hereinafter the vibrations v1 may be called “machining vibrations”, while the vibrations v2 may be called “tool vibrations” or “machine vibrations”.

According to the invention, next steps are preferred to reach its aim:
detect the fundamental frequency and/or harmonic frequencies of the vibrations v1 and the fundamental frequency and/or harmonic frequencies of the vibrations v2;
determine the extent of the coincidence between the fundamental frequency and/or harmonic frequencies of the vibrations v1 and the fundamental frequency and/or harmonic frequencies of the vibrations v2;
if the extent of coincidence between the fundamental frequency and/or harmonic frequencies of the vibrations v1 and at least one of any of the fundamental frequency and/or harmonic frequencies of the vibrations v2 is within a certain range, the vibration causing said coincidence between the fundamental frequency and/or harmonic frequencies of the vibrations v1 and at least one of any of the fundamental frequency and/or harmonic frequencies of the vibrations v2 is counteracted.

In many cases it may be preferred to counteract said coincidence between the fundamental frequency and/or harmonic frequencies of the vibrations v1 and at least one of any of the fundamental frequency and/or harmonic frequencies of the vibrations v2—which may form a threat for mechanical resonant rise and/or system instabilities—by changing one or more machining parameters, like speed, material supply etc., thus influencing the machining vibrations v1 and take away the threat. At least some machining parameters could be changed by using passive or active components (e.g. actuators).

Said coincidence, however, may additionally or instead, be counteracted by changing the (vibrational) characteristics of the milling machine itself, e.g. by means of passive or active components (e.g. actuators), thus influencing the machine vibrations v2 and take away the threat that way.

The invention includes a system which is arranged to perform the method as outlined hereinabove under control of control means, the system comprising relevant detection means for vibration detection, determination means for determining possible mechanical resonance threat, and counteracting means, e.g. comprising passive or active components, for counteracting the resonance threat.

Advantageous of the preferred method and system presented here is the avoidance of chatter and suppression of vibration during machining (in process), aiming at combined efficiency and accuracy improvements. This approach is very applicable to processes with e.g. very varying machining conditions as well for machining with constant machining conditions.

### EXEMPLARY EMBODIMENT

FIG. 1 shows a block diagram of the milling process;

FIG. 2 shows a diagram of the control system;

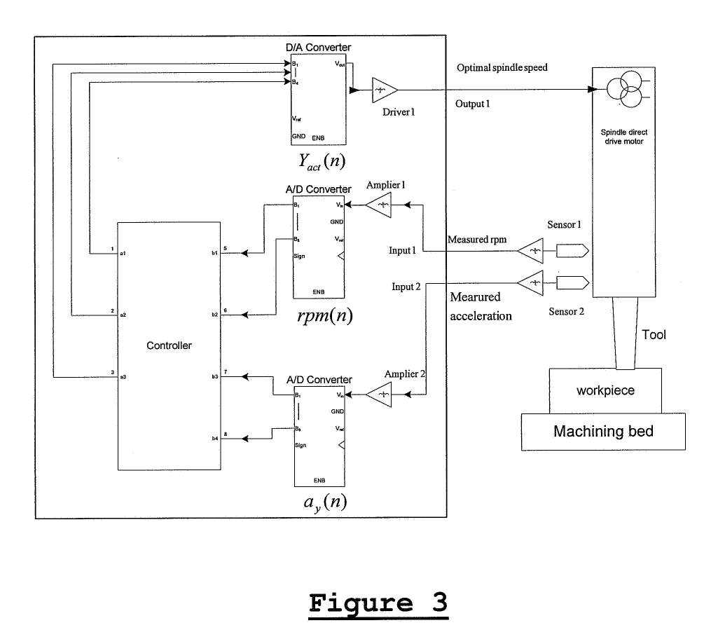

FIG. 3 shows a chatter control system using one actuator system;

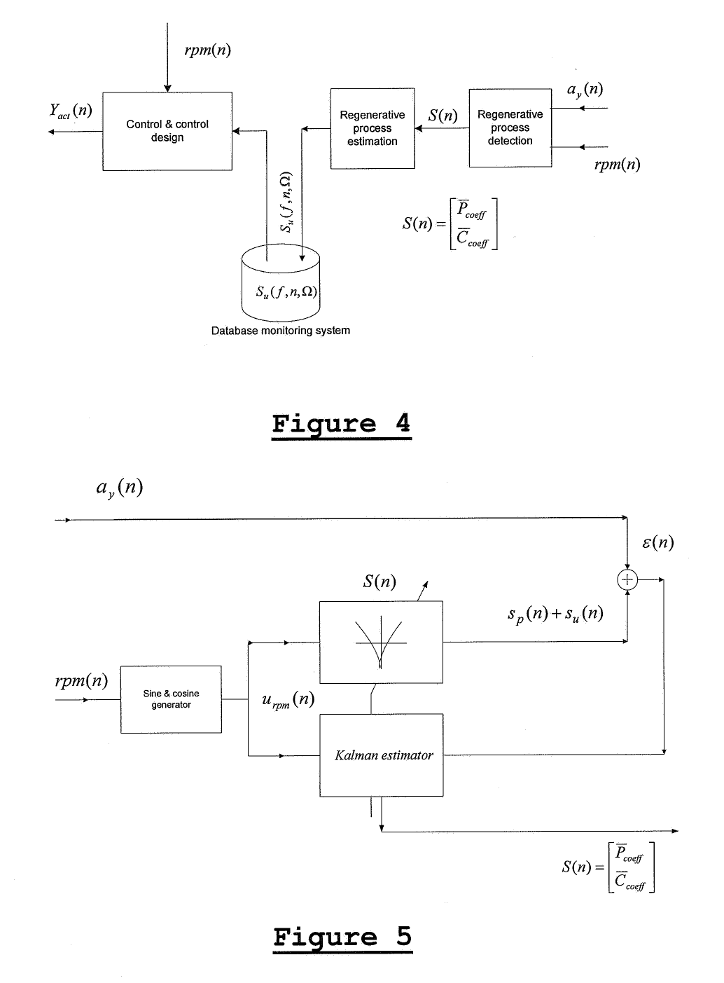

FIG. 4 shows an outline of the control algorithm;

FIG. 5 illustrates detection of RP;

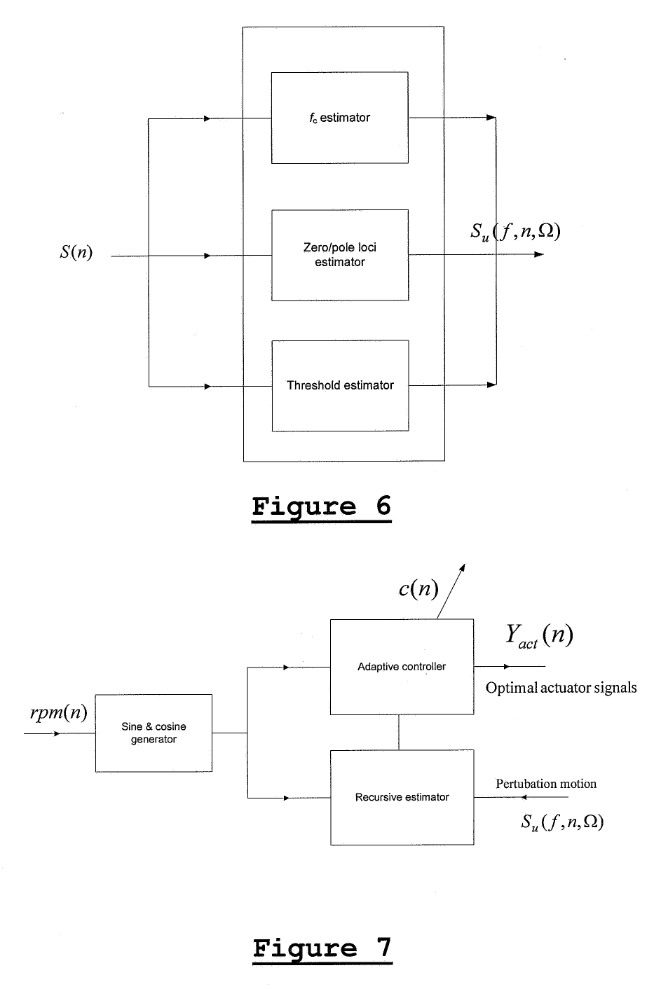

FIG. 6 illustrates the estimation of the regenerative process;

FIG. 7 illustrates adaptive control and control design.

Turning to FIG. 1 first, the phenomena of chatter are intuitively better understood by considering the milling process as a mechanical control system with a positive feedback loop. Herein the input of the system is a milling chip thickness as set by the relative position of the tool and the workpiece, which is a sum of a thickness Rstat due to setting of the milling tool and a dynamic thickness setting component Rdyn due to chatter. The sum is indicated by a circle in the figure. The cutting process results in a force F dependent on the milling chip thickness. This effect is indicated by the box titled “cutting process”. The machine dynamics in turn result in vibrations, which are a sum of vibrations Sp due to cutting forces and vibrations Su due to chatter and its onset. This effect is indicated by the box titled “machine dymamics”. The vibrations and the geometry of the tool in turn define the dynamic milling chip thickness (or a time derivative thereof). This is indicated by the box “trigonometric functions”

From the figure it can be seen that the system is configured as a ‘regenerative vibrations process’, and is therefore inherent unstable.

One aspect to prevent chatter is to maintain the synchronization of succeeding wavy surfaces, keeping dynamic chip thickness R_{dyn}(t) constant. Machine designers use passive strategies to prevent regenerative vibrations by absorbing the vibration energy, or by redirecting the vibration energy [Semercigil and Chen, 2002; Tarng et al, 2000]. A new trend in the design approach to control chatter behaviour, is to optimize the machine's dynamic behaviour at the design process, maximizing stiffness and optimizing damping of the entire cutting system [Zhang and Sims, 2005; Kyung and Lee, 2003].

The objective of the abovementioned strategies is to minimize the energy feedback of the unwanted regenerative vibrations to the cutting process for a vast range of machining parameters. From a control-engineering viewpoint, these design strategies focus on a control (indirectly) of the properties of the regenerative vibration process, by ‘tuning’ the machine dynamics at the design process [Altintas and Cao, 2005].

The general disadvantage of many existing solutions is that all countermeasures to prevent chatter are performed off line, thus not during milling. The main disadvantage is that the existing solutions try to predict (in advance, thus offline) spindle speed regions of stable machining, which are less sensitive to chatter. The set of machining parameters is then determined. The prediction is done only once prior to the machining. Case studies and practical experience have shown that this strategy is limited and only apply to processes with very constant machining conditions (e.g. machining of large aero frame structures of aluminium). In other industrial areas, like mould making and precision part production, this strategy is not possible because of varying process conditions.

A more elegant approach is controlling the regenerative vibration process during milling actively, which means sensing the milling process, detecting and estimating chatter in an early stage and eventually actively control the mechanical feedback path properties to prevent full blown chatter. Two approaches are possible:

I. Changing the dynamic properties of the mechanical feedback path during milling, by exciting the machine dynamics, using actuators (e.g. shakers or piezo stacks), maximizing stiffness and optimizing damping of the entire cutting system. A control system could provide the optimal actuator signals. A drawback of this approach may be that the dynamics of the cutting system has to be accurately modelled in advance to achieve robust performances. Dynamic changes during milling may deteriorate the performance of the control system and the system thus may fail. A need to track model changes would be necessarily to maintain robust performances.
II. Another method is based on eliminating the feedback path to the cutting process, in which case the dynamic chip thickness (R_{dyn}(t)) would be zero. In practice only partial elimination of the feedback path would be possible for a small selectable frequency region, which coincides with the chatter frequency. This will minimize the energy feedback of the unwanted regenerative vibrations to the cutting process for the selected frequency region. An actuator signal can be extracted from the chatter frequency, the harmonic frequency of the spindle rotation frequency, which coincides with the chatter frequency. The relevant control algorithm is simple and straight forward. The major advantage of this approach is, that there is no need to model the cutting system in advance or keep track of changes in the dynamic behaviour of the system during cutting. In this preferred method according to the invention only the detection and estimation of the chatter frequency has to be performed during the milling process. The preferred control strategy presented here effectively opens a positive feedback loop and cancels out any regenerative mechanism for a selectable frequency region.

To realize this approach a number of properties of the milling process may need to be detected or estimated in the process, e.g.
a. detection of onset of chatter;
b. detection of chatter frequency f_{c};
c. estimation of the harmonic frequency f_{harmonic} of the spindle speed, which coincides with the chatter frequency;
d. estimation of the (energy) transfer function between the spindle speed and the regenerative process (chatter) in the frequency range f_{c} and f_{harmonic}.

After this, next actions could be taken:
e. change the energy transfer function, by actuating the spindle system with e.g. a 1 to 5 DOF (degrees of freedom) actuator system in the frequency range f_{c} and f_{harmonic};
f. calculate real time the optimal actuator signal.

FIG. 2 shows a block diagram of a control system, comprising sensors, a controller, power amplifiers and actuators. The machining bed, a workpiece, a spindle system and a tool are shown as well. The sensors sense the revolution speed and acceleration of the spindle system. The controller performs process to detect and estimate chatter (labeled Detection and estimation of chatter) and a control design process to derive actuator signals from the detected and estimated chatter, which is represented by a state value Su computed from the frequency and accelerations by the process to detect and estimate chatter. The actuator signals are used to control the actuators via the power amplifiers.

FIG. 2 shows that during machining two types of sensors may be used to measure and to digitize the spindle speed (rpm) and the vibration (acceleration) of the bottom spindle bearing. The controller processes the measured signals to detect and estimate the perturbation motion sᵤ(t,Ω), which is used as measure for chatter. The ‘control design’ process performed by the controller calculates the optimal actuator signals to excite the spindle system (by exciting the spindle dynamics, using shakers or piezo stacks) with the main objective to minimise the perturbation motion sᵤ(t,Ω). This control process effectively minimises the energy transfer between the spindle speed and the regenerative process in the frequency range f_{c} and f_{harmonic}. Eventually the regenerative mechanism will be cancelled out.

The relative simple implementation is the use of a one actuator system to excite 1 DOF. The direct drive motor of the spindle system is used as actuator to excite the dynamics of the spindle system. In this case the rotation of the spindle system is changed to minimise the perturbation motion sᵤ(t,Ω). The ‘control design’ calculates the optimal spindle speed at which the energy transfer function is minimised. The interface to the controller for this purpose is shown in more detail in FIG. 3, comprising amplifiers and A/D converters to convert the sensor signals to digital signals. A demonstrator has been implemented on a controller of a Dspace control system.

The algorithm is decomposed in 3 functionalities as depicted in FIG. 4:
Detection of the regenerative process (FIG. 5);
Estimation of the regenerative process (FIG. 6);
Adaptive control and control design (FIG. 7).

In FIG. 4, the inputs are a sensor signal a_{y}(n) and a rotation frequency sensor signal. These may be sampled at a frequency of for example 10 kHz. Regenerative process detection uses the sensor signals to compute a state value (e.g. state vector) S. From this the regenerative process is estimated. By means of a database an input for the control design process is obtained using the rotation frequency to compute actuator signals Y.

FIG. 5 illustrates detection of the regenerative process. Herein the state vector S(n) is computed from observed sensor signals a_{y}(n) and observed tool rotation frequency rpm(n) The state vector S(n) represents parameters of an adjustable model that is used to predict a sum of vibration signal values Sᵤ and Sₚ due to cutting forces and (onset of) chatter. The difference epsilon between the observed sensor signal and these predictions is used to adapt the state vector S(n).

A general Parametric model (1) is selected for the detection and estimate the regenerative process (RP) (see FIGS. 5 and 6).

$$A ( q ) y ( n ) = \frac{B ( q )}{F ( q )} u ( n ) + \frac{C ( q )}{D ( q )} e ( n ) , n = time index \qquad ( 1 )$$

Selecting the order of the filter polynomials A(q) up to F(q) determines the type of model for the RPM periodic components ŝₚ(n) and the perturbation motion ŝᵤ(n). In a simple model A, C and F may be set to a constant value, such as one, i.e. with an order of zero.

In the model the predicted sensor signal â_{y} is a sum of a predicted vibration ŝp due to cutting forces and a predicted vibration ŝu due to (onset of) chatter. According to the model predicted vibration ŝp due to cutting forces only has frequency components at selected frequencies corresponding integer multiples of the revolution frequency of the tool (including the basic revolution frequency, i.e. a multiple of 1). In contrast the model holds that the predicted vibration ŝu due to (onset of) chatter has frequency components over a (quasi-) continuous frequency range. This makes it possible to identify the different components individually.

The predicted vibration ŝp due to cutting forces is modeled as a filtered version B(q)u(n) of a periodic excitation signal u(n) at a frequency corresponding to the observed rotation frequency. Herein B(q)u(n) represents the result of applying a FIR filter with a predetermined number of adjustable coefficients (twenty coefficients for example, labeled with the index q) to the signal u(n). The predicted vibration ŝu due to (onset of chatter) is modeled as a response to a random signal ξ filtered with a filter function that is symbolically represented as 1/D(q), D(q) may be represented by FIR filter response with a predetermined number of adjustable coefficients, so that 1/D(q) represents a filter with a predetermined number of poles. A function with two poles may be used for example. Putting these terms together:

$${{a}^{⋒}}_{y} ( n ) = {\hat{s}}_{p} ( n ) + {\hat{s}}_{u} ( n ) = B ( q ) u ( n ) + \frac{1}{D ( q )} ξ ( n ) \qquad ( 2 )$$

herein u(n) is a modeled excitation function with, frequency components at integer multiples of the frequency of revolution fᵣₚₘ of the tool:

$${u}_{rpm} ( n ) = {\sum }_{k = 1}^{N} \{ cos ( 2 π {kf}_{rpm} n ) + i sin ( 2 π {kf}_{rpm} n ) \} \qquad ( 3 )$$

As the adjustable filter B(q) shapes the response, an arbitrary excitation function with such frequency components may be used. ξ(n), is a white noise signal with, zero mean, and variance

σ²=1. (4)

As the adjustable filter 1/D(q) shapes the noise, the same results may be realized within a range of noise process selections.

From measured cutter movement a_{y}(n), the prediction error becomes:

f_{R}(n)=a_{y}(n)− [symbol] (n−1) (5)

The model parameters, that is, the adjustable coefficients of B and D, may be adapted dynamically as a function of time, using Kalman estimator techniques for example, so that the prediction error is minimized. The time update of the model may be performed using the algorithm scheme (6 . . . 9)

\hat{θ}(n)=[Bₙ(q)Dₙ⁻¹(q)] (6)

(a vector having as components the filter B and the filter D⁻¹).

\hat{θ}(n)=\hat{θ}(n−1)+K(n)f_{R}(n) (7)

K(n)=Φ(n)ψ(n) (8)

Herein ψ is a vector with components u (see the preceding) and v=(1/D)ξ:

ψ(n)=[u(n)υ(n)]^{T} (9)

Φ is the vector square ψ

The coefficients of Bₙ(q) describe the properties of the RPM periodic components sₚ(n);

The coefficients of Dₙ(q) describe the properties of the perturbation motion sᵤ(n). Dₙ(q) models the perturbation motion sᵤ(n) as a mathematical function and with well known tools the chatter frequency f_{c}(n) and the state space S(n)=Vᵤ(f, n, Ω) can be calculated.

As shown in FIG. 6 the coefficients of B and/or D (i.e. state S) can be used to determine further state parameters. The position of the zeros of the Fourier transform of D can be used to determine a peak frequency fc of chatter, and a damping factor of chatter (e.g. from an imaginary part of the frequency of zeros of the Fourier transform of D).

Furthermore a threshold may be computed to disable adaptive control of the tool when no reliable estimate of chatter parameters is available, for example from an error function in the adaptation of the coefficients of B and D.

Summarizing, a model is used that makes it possible to identify the components directly due to the tool and component due to chatter. Model parameters of the model are estimated together, by minimizing a prediction error, and the part of the parameters that relates to chatter are used to determine a state of the chatter. More specifically the model defines a signal part with frequency components at integer multiples of the frequency of revolution of the tool and a part with a signal part with a (quasi-) continuous range of frequency components. Parameters of both parts are estimated in combination and the parameters of the latter part are used to determine the state of the chatter. In the specific example of the embodiment the signal part with frequency components at integer multiples of the frequency of revolution of the tool is modeled as the effect B(q)u(n) of a FIR filter with adjustable coefficients B(q) applied to an excitation function u(n). In this example the signal part with a (quasi-) continuous range of frequency components is modeled as the effect 1/(D(q) ξ of a filter 1/D(q) applied to a random signal ξ.

The estimated model parameters are used to adapt actuator signals Y in a direction that reduces the amplitude of estimated chatter sᵤ. This amplitude may be derived from the coefficients of D. In an embodiment, this may be done by determining the integer multiple of the rotation frequency of the tool that is closest to the peak of signal part 1/(D(q) ξ and changing the rotation frequency in a direction so that this integer multiple moves away from the position of this peak. In an embodiment where the tool has a cutter with a plurality of N_{c} teeth that contact the workpiece in turn during a revolution of the cutter, the direction may instead be chosen so that the nearest integer multiple of Nc times the frequency of revolution relative to the peak moves away from the position of the peak. The size of the change of rotation frequency may be varied, dependent on the amplitude of the peak. Alternatively, different directions of adaptation may be tried until a direction is found wherein the chatter component according to the model is reduced and the adaptation may be increased until minimum chatter is reached or adaptation is disabled.

A recursive estimator may adapt the setting of an adaptive controller that determines the actuation signals based on the rotation frequency. The recursive estimator uses information derived from the coefficients of the model (e.g. dynamically estimated coefficients of D) to adapt the adaptive controller.

The adaptation of the actuator signals Y may continue dynamically while the tool is operating on the workpiece. The coefficients of D and B may also be estimated dynamically while the tool is operating on the workpiece. In this way a much faster feedback is obtained than by, say, computing a Fourier transform of a large number of samples, which allows only sparse updates at a periodic interval determined by the number of samples used in the Fourier transform. A closed loop may be used wherein there is no interruption of control of the cutting process to accommodate the adaptation.

Referring to FIG. 7 now for an example of adaptation, the control coefficients c(n) are estimated using a gradient-based adaptation. The implementation of the gradient is a recursive algorithm. c(n) will evolve with time index n.

Y_{act} (n)=RPM_{eff}(n) is the effective spindle speed and calculated using formula (11)

The algorithm

RPM_{eff}(n)=RPMᵢₙᵢₜ(1+c(n)) (10)

The recursive adaptation of RPM is performed by adapting c(n) according to as a function of time n

$$c ( n ) = c ( n - 1 ) - μ \{ Θ ( n ) \} sign ( {f}_{onset} ( n ) ) \\ Θ ( n ) = \vert α \frac{\{ V ( {f}_{c} , n ) - {δ}_{0} \}}{pow ( V ( {f}_{c} , n ) )} \vert \\ {f}_{onset} ( n ) = {K}_{int} ( n ) - {K}_{frac} ( n ) \\ {K}_{int} = harmonic number at which {f}_{c} is manifest \qquad ( 11 )$$

For Kint see the following. Herein μ(Θ(n)) may be equal to a factor times Θ(n) and α may be a constant of proportionality. The sign of fₒₙₛₑₜ represents the direction of the closest integer multiple of Nc times the rotation frequency frpm of the tool to the position fc of the peak of the signal part 1/(D(q) ξ. This determines the direction of change of the rotation frequency frpm. The amplitude of the change may be made dependent on V(fc,n) is the amplitude of the peak, compared to a threshold value δ₀ and normalized by the signal power in the peak.

In addition the amplitude of the change may be limited so that the power rotation of the tool is limited, for example by adding a term proportional to the difference between the current measured power needed for rotation and a nominal value to the expression for Θ(n), for example before taking the absolute value (within the bars ∥).

The frequency terms may be defined as follows.

$$\begin{matrix}{K}_{int} ( n ) = {N}_{z} ⋆ int \{ 0.5 + \frac{{f}_{c} ( n )}{{N}_{z} ⋆ {f}_{rpm} ( n )} \} & ( 12 ) \\ {K}_{frac} ( n ) = \frac{{f}_{c} ( n )}{{f}_{rpm}} - {N}_{z} ⋆ int \{ 0.5 + \frac{{f}_{c} ( n )}{{N}_{z} ⋆ {f}_{rpm} ( n )} \} & ( 13 )\end{matrix}$$

Herein N_{z}=number of teeth on the cutter, so that Kint represents the nearest multiple of frpm times Nz (divided by Nz*frpm), near the peak frequency fc. Alternatively, N_{z} may be replaced by 1, but it has been found that a better effect is obtained when N_{z} used.

1. A method of reducing milling failure in a machining tool due to interaction between a fundamental frequency and/or at least one harmonic frequency of first vibrations v1 substantially caused by mutually exerted forces between the machining tool and an object being machined, and a fundamental frequency and/or at least one harmonic frequency of second vibrations v2 substantially caused by mechanical resonance by or in the machining tool itself and/or one or more subsystems of the machining tool, the method comprising the steps of:
generating dynamically adapted parameters of a combined model of a cutting process and chatter to minimize prediction errors between measured sensor signal values and predictions based on the combined model; and
controlling an actuator signal based on the dynamically adapted parameters of the combined model, the actuator signal being changed in a direction to reduce chatter predicted by the combined model.

2. The method according to claim 1 wherein a model is used for the combined model that predicts the measured sensor signal values as a sum of:
a part with frequency components only at a rotation frequency of the machining tool and integer multiples thereof, and
a part modeling a response to noise comprising frequency components outside the rotation frequency and integer multiples thereof.

3. The method according to claim 2, comprising measuring the rotation frequency and using the measured rotation frequency in the generating dynamically adapted parameters step.

4. The method according to claim 1, wherein the controlling step comprises adapting a rotation frequency of the tool, based on information derived from parameters of the combined model, in a direction so as to move an integer multiple of the rotation frequency away from a peak frequency of chatter defined by the combined model, wherein the integer multiple is selected as a closest integer multiple of the rotation frequency to the peak frequency in a set of integer multiples of the rotation frequency.

5. The method according to claim 4, wherein the integer multiple is a closest integer multiple of Nz times the rotation frequency near the peak frequency, wherein Nz is a number of teeth present on a cutting tool.

6. The method according to claim 1 comprising:
detecting the fundamental frequency and/or harmonic frequencies of the vibrations v1 and the fundamental frequency and/or harmonic frequencies of the vibrations v2;
determining an extent of coincidence between the fundamental frequency and/or harmonic frequencies of the vibrations v1 and the fundamental frequency and/or harmonic frequencies of the vibrations v2;
if the extent of coincidence between the fundamental frequency and/or harmonic frequencies of the vibrations v1 and at least one of any of the fundamental frequency and/or harmonic frequencies of the vibrations v2 is within a certain range, counteracting the vibration causing the coincidence between the fundamental frequency and/or harmonic frequencies of the vibrations v1 and at least one of any of the fundamental frequency and/or harmonic frequencies of the vibrations v2.

7. The method according to claim 6, wherein, to counteract the coincidence between the fundamental frequency and/or harmonic frequencies of the vibrations v1 and at least one of any of the fundamental frequency and/or harmonic frequencies of the vibrations v2, one or more machining parameters are changed.

8. The method according to claim 6, wherein, to counteract the coincidence between the fundamental frequency and/or harmonic frequencies of the vibrations v1 and at least one of any of the fundamental frequency and/or harmonic frequencies of the vibrations v2, relevant vibrational characteristics of the machining tool are changed.

9. The method according to claim 7, wherein the one or more machining parameters are changed and/or the relevant vibrational characteristics of the machining tool itself are changed by either passive or active components.

10. A system for reducing milling failure in a machining tool due to interaction between a fundamental frequency and/or at least one harmonic frequency of first vibrations v1 substantially caused by mutually exerted forces between the machining tool and an object being machined, and a fundamental frequency and/or at least one harmonic frequency of second vibrations v2 substantially caused by mechanical resonance by or in the machining tool itself and/or one or more subsystems of the machining tool, the system comprising
sensors to detect a rotation frequency of the machining tool and movement of the object;
a controller configured to:
generate dynamically adapted parameters of a combined model of a cutting process and chatter to minimize prediction errors between measured sensor signal values and predictions based on the combined model; and
control an actuator signal based on the dynamically adapted parameters of the combined model, the actuator signal being changed in a direction to reduce chatter predicted by the combined model.

11. The system according to claim 10, wherein the combined model is a model for predicting the measured sensor signal values as a sum of:
a part with frequency components only at a rotation frequency of the machining tool and integer multiples thereof, and
a part modeling a response to noise comprising frequency components outside the rotation frequency and integer multiples thereof.

12. The system according to claim 11, wherein the controller is configured to use the measured rotation frequency in the generating dynamically adapted parameters step.

13. The system according to claim 10, wherein the controller is configured to adapt a rotation frequency of the tool, based on information derived from parameters of the combined model, in a direction so as to move an integer multiple of the rotation frequency away from a peak frequency of chatter defined by the combined model, wherein the integer multiple is selected as a closest integer multiple of the rotation frequency to the peak frequency in a set of integer multiples of the rotation frequency.

14. The system according to claim 10 comprising:
detection means to detect the fundamental frequency and/or harmonic frequencies of the vibrations v1 and the fundamental frequency and/or harmonic frequencies of the vibrations v2;
determination means cooperating with the detection means and arranged to determine an extent of coincidence between the fundamental frequency and/or harmonic frequencies of the vibrations v1 and the fundamental frequency and/or harmonic frequencies of the vibrations v2;
counteracting means cooperating with the determination means and arranged to counteract, if the extent of coincidence between the fundamental frequency and/or harmonic frequencies of the vibrations v1 and at least one of any of the fundamental frequency and/or harmonic frequencies of the vibrations v2 is within a certain range, the vibration causing the coincidence between the fundamental frequency and/or harmonic frequencies of the vibrations v1 and at least one of any of the fundamental frequency and/or harmonic frequencies of the vibrations v2.

15. The system according to claim 14, the counteracting means being arranged to change one or more machining parameters.

16. The system according to claim 14, the counteracting means being arranged to change relevant vibrational characteristics of the machining tool.

17. The system according to claim 15, the counteracting means comprising passive and/or active components arranged to change the one or more machining parameters and/or to change the relevant vibrational characteristics of the machining tool.

18. A computer program product comprising a program of instruction that, when executed by a programmable controller cause the controller to perform the method of claim 1.
